(19) United States
(12) Patent Application Publication
(10) Pub. No.: US 2018/0194897 A1
(43) Pub. Date: Jul. 12, 2018

(54) METHOD FOR PRODUCING A POLYAMIDE

(71) Applicant: BASF SE, Ludwigshafen am Rhein (DE)

(72) Inventors: Philippe Desbois, Edingen-Neckarhausen (DE); Rene Arbter, Freinsheim (DE); Bernd Bruchmann, Freinsheim (DE); Robert Stein, Altrip (DE); Frank Thielbeer, Mannheim (DE); Rolf Muelhaupt, Freiburg (DE); Tina Andrae, Mittweida (DE)

(21) Appl. No.: 15/742,215

(22) PCT Filed: Jul. 5, 2016
(86) PCT No.: PCT/EP2016/065878

§ 371 Date: Jan. 5, 2018

(30) Foreign Application Priority Data
Jul. 6, 2015 (EP) 15175479.3

(51) Int. Cl. C08G 69/20; C08G 69/14

(52) U.S. Cl. CPC C08G 69/20; C08G 69/14

(57) ABSTRACT

A process for the production of a polyamide is disclosed. The process for production of a polyamide (P) comprises mixing a first mixture (M1), which comprises at least one lactam and at least one catalyst, with a second mixture (M2), which comprises at least one lactam, at least one activator and at least one amine, to give a polymerizable mixture (pM) and then polymerization of the polymerizable mixture (pM) to give the polyamide (P). A polyamide (P) obtainable by the process of the invention is also disclosed, as well as moldings made of the polyamide (P).

The present invention relates to a process for the production of a polyamide (P) by mixing of a first mixture (M1), which comprises at least one lactam and at least one catalyst, with a second mixture (M2), which comprises at least one lactam, at least one activator and at least one amine, to give a polymerizable mixture (pM) and then polymerization of the polymerizable mixture (pM) to give the polyamide (P). The present invention also relates to a polyamide (P) obtainable by the process of the invention, and also to moldings made of the polyamide (P).

Polyamides are generally semicrystalline polymers which are of particular industrial importance because they feature very good mechanical properties. In particular, they have high strength, stiffness and toughness, good chemicals resistance, and also high abrasion resistance and tracking resistance. These properties are particularly important for the production of injection moldings. High toughness is particularly important for the use of polyamides as packaging films. The properties of polyamides provide access to industrial applications for the production of textiles, for example fishing lines, climbing ropes and carpeting. Polyamides are also used for the production of anchors, bolts and cable ties. Polyamides are moreover used in the form of adhesives, coatings and coating materials.

Polyamide moldings are advantageously produced by polymerization of the corresponding monomers directly in the mold, starting from monomer powder, the polymerization reaction being started in situ. The requirement is generally merely heating to a temperature above the melting point of the monomer and not above the melting point of the polymer, which is usually higher than the melting point of the monomer.

The prior art describes various processes for the production of polyamides.

DE 1 495 132 describes by way of example the polymerization of a lactam mixture which can comprise an acyl chloride and an isocyanate or a compound that cleaves to give isocyanate, via addition of an alkali metal lactamate solution which comprises primary and/or secondary mono- and/or polyamines. The alkali metal lactamate solution can likewise comprise an acyl chloride and an isocyanate or a compound that cleaves to give isocyanate.

DE 4 002 260 describes the anionic polymerization of a caprolactam mixture which can comprise acyl chlorides, isocyanates, substituted ureas, urethanes or guanidines, via addition of a catalyst solution which comprises a lactam, an alkali metal, and also poly-C₁-C₄-alkylene glycol and a primary and/or secondary mono- and/or polyamine.

Processes described in the prior art have the disadvantage that the polymerization of the lactam begins immediately when the temperature is increased. The components are usually already in liquid form when they are charged to the mold. The polymerization of the lactam therefore begins directly after charging of the components to the mold. The polymerization reaction generally starts before all of the components have been charged completely to the mold. This leads to nonuniform polymerization and therefore to moldings which are sometimes unstable or distorted. A particular disadvantage is that the components are often mixed with one another in a mixing head before they are charged to the mold. The polymerization reaction then often begins in the mixing head, and this can lead to blockage thereof.

The object underlying the present invention therefore consists in the provision of a process for the production of polyamides which does not have the disadvantages of the processes described in the prior art, or has said disadvantages only to a reduced extent.

Said object is achieved via a process for the production of a polyamide (P), comprising the following steps:
a) provision of a first mixture (M1) which comprises the following components:
   (A) at least one lactam,
   (B) at least one catalyst,
b) provision of a second mixture (M2) which comprises the following components:
   (A) at least one lactam,
   (C) at least one activator,
   (D) at least one amine,
c) mixing of the first mixture (M1) with the second mixture (M2) to give a polymerizable mixture (pM),
d) polymerization of the polymerizable mixture (pM) obtained in step c) to give the polyamide (P).

Surprisingly, it has been found that the use of a first mixture (M1) and a second mixture (M2) in the process of the invention retards the start of polymerization of the polymerizable mixture (pM), so that the polymerizable mixture (pM) exhibits an induction period before the start of polymerization.

After the induction period, polymerization of the polymerizable mixture (pM) proceeds rapidly and completely, so that homogeneous polyamides are obtained and therefore the moldings produced therefrom are also particularly homogeneous and have good mechanical properties. The residual monomer content in the resulting polyamides (P) is moreover particularly low.

The properties of the polyamide (P) produced in the invention are almost identical with the properties of polyamides produced by other processes described in the prior art. By way of example the densities of the polyamide (P) produced in the invention and of the polyamides obtainable by processes described in the prior art are identical, and their behavior in dynamic-mechanical analysis (DMA) and in differential scanning calorimetry (DSC) is similar.

With the polyamide (P) produced in the invention it is possible to achieve faster charging to a mold used for the production of moldings from the polyamide (P).

Moldings produced from the polyamide (P) perform particularly well in removal from the mold.

The process of the invention is explained in more detail below.

Step a)

In step a) a first mixture (M1) is provided. The first mixture (M1) comprises at least one lactam as component (A) and at least one catalyst as component (B).

For the purposes of the present invention, the expression “at least one lactam” means either precisely one lactam or else a mixture made of two or more lactams. The same applies to the expression “at least one catalyst”. The expression “at least one catalyst” means either precisely one catalyst or else a mixture of two or more catalysts.

The first mixture (M1) is also termed catalyst solution or initiator solution.

The first mixture (M1) can also comprise further components in addition to the at least one lactam and the at least one catalyst. Examples of further components are alkylene glycols, in particular poly-C₂-C₄-alkylene glycols, for example polyethylene glycol, polypropylene glycol, polytetrahydrofuran and copolymers of these.

Other examples of further components which can be comprised in the first mixture (M1) are reaction products of the reaction of the at least one catalyst (component (B)) with at least one lactam (component (A)). These reactions and reaction products are known per se to the person skilled in the art.

It is preferable that the first mixture (M1) provided in step a) comprises no further components other than optionally the reaction products of the reaction of the at least one catalyst (component (B)) with the at least one lactam (component (A)).

With particular preference, the first mixture (M1) comprises no component (C), at least one activator.

The present invention therefore also provides a process in which the first mixture (M1) provided in step a) comprises no component (C), at least one activator.

The statements and preferences described at a later stage below for component (C) apply correspondingly to the at least one activator.

With particular preference, moreover, the first mixture (M1) comprises no component (D), at least one amine.

The present invention therefore also provides a process in which the first mixture (M1) provided in step a) comprises no component (D), at least one amine.

The present invention moreover provides a process in which the first mixture (M1) provided in step a) comprises no component (C), at least one activator, and no component (D), at least one amine.

The first mixture (M1) provided in step a) can comprise any desired quantities of components (A) and (B). It is preferable that the first mixture (M1) comprises from 50 to 99.9% by weight of component (A), particularly from 70 to 99% by weight and in particular from 80 to 99% by weight, based on the total of the percentages by weight of components (A) and (B), preferably based on the total weight of the first mixture (M1).

It is preferable moreover that the first mixture (M1) comprises from 0.1 to 50% by weight of component (B), particularly from 1 to 30% by weight and in particular from 1 to 20% by weight, based in each case on the total of the percentages by weight of components (A) and (B), preferably based on the total weight of the first mixture (M1).

The present invention therefore also provides a process in which the first mixture (M1) provided in step a) comprises from 50 to 99.9% by weight of component (A) and from 0.1 to 50% by weight of component (B), preferably from 70 to 99% by weight of component (A) and from 1 to 30% by weight of component (B) and with particular preference from 80 to 99% by weight of component (A) and from 1 to 20% by weight of component (B), based in each case on the total of the percentages by weight of components (A) and (B), preferably based on the total weight of the first mixture (M1).

The percentages by weight of components (A) and (B), and also optionally of the further components comprised in the first mixture (M1), usually give a total of 100%. If there are no further components comprised in the first mixture (M1), the percentages by weight of components (A) and (B) give a total of 100%.

The first mixture (M1) can be provided in any of the devices known to the person skilled in the art, for example in a kettle or an extruder.

Component (A): lactam

In the invention, the first mixture (M1) comprises at least one lactam as component (A).

The expressions “component (A)” and “at least one lactam” are used synonymously in the present invention and therefore have the same meaning.

The term “lactam” in the invention means cyclic amides which have from 4 to 12 carbon atoms in the ring, preferably from 6 to 12 carbon atoms.

The present invention therefore also provides a process in which component (A) comprises at least one lactam having from 4 to 12 carbon atoms.

Examples of suitable lactams are selected from the group consisting of 4-aminobutanoic lactam (γ-lactam; γ-butyrolactam; pyrrolidone), 5-aminopentanoic lactam (δ-lactam; δ-valerolactam; piperidone), 6-aminohexanoic lactam (ε-lactam; ε-caprolactam), 7-aminoheptanoic lactam (ζ-lactam; ζ-heptanolactam; enantholactam), 8-aminooctanoic lactam (η-lactam; η-octanolactam; caprylolactam), 9-nonanoic lactam (θ-lactam; θ-nonanolactam), 10-decanoic lactam (ω-decanolactam; capric lactam), 11-undecanoic lactam (ω-undecanolactam) and 12-dodecanoic lactam (ω-dodecanolactam; laurolactam).

The present invention therefore also provides a process in which component (A) is selected from the group consisting of pyrrolidone, piperidone, ε-caprolactam, enantholactam, caprylolactam, capric lactam and laurolactam.

The lactams can be unsubstituted or at least monosubstituted. If at least monosubstituted lactams are used, these can bear, on the ring carbon atoms, one, two or more substituents selected mutually independently from the group consisting of C₁- to C₁₀-alkyl, C₅- to C₆-cycloalkyl and C₅- to C₁₀-aryl.

It is preferable that component (A) is unsubstituted.

Examples of suitable C₁- to C₁₀-alkyl substituents are methyl, ethyl, propyl, isopropyl, η-butyl, sec-butyl and tert-butyl. An example of a suitable C₅- to C₆-cycloalkyl substituent is cyclohexyl. Preferred C₅- to C₁₀-aryl substituents are phenyl and anthranyl.

It is particularly preferable to use unsubstituted lactams, preference being given here to 12-dodecanoic lactam (ω-dodecanolactam) and ε-lactam (ε-caprolactam). Most preference is given to ε-lactam (ε-caprolactam).

ε-Caprolactam is the cyclic amide of caproic acid. It is also termed 6-aminohexanoic lactam, 6-hexane lactam or caprolactam. Its IUPAC name is “Acepan-2-one”. Caprolactam has the CAS number 105-60-2 and the general formula C₆H₁₁NO. Processes for the production of caprolactam are known to the person skilled in the art.

Component b): Catalyst

In the invention, the first mixture (M1) comprises at least one catalyst as component (B).

The expressions “component (B)” and “at least one catalyst” are used synonymously in the present invention and therefore have the same meaning.

The at least one catalyst is preferably a catalyst for the anionic polymerization of a lactam. The at least one catalyst therefore preferably permits the formation of lactam anions. The at least one catalyst is therefore able to form lactamates by removing the nitrogen-bonded proton of the at least one lactam (component (A)).

Lactam anions per se can likewise function as the at least one catalyst. The at least one catalyst can also be termed initiator.

Suitable components (B) are known per se to the person skilled in the art and are described by way of example in “Polyamide. Kunststoff-Handbuch” [Polyamides, Plastics handbook], Carl-Hanser-Verlag 1998.

It is preferable that component (B) is selected from the group consisting of alkali metal lactamates, alkaline earth metal lactamates, alkali metals, alkaline earth metals, alkali metal hydrides, alkaline earth metal hydrides, alkali metal hydroxides, alkaline earth metal hydroxides, alkali metal alcoholates, alkaline earth metal alcoholates, alkali metal amides, alkaline earth metal amides, alkali metal oxides, alkaline earth metal oxides and organometallic compounds.

The present invention therefore also provides a process in which component (B) is selected from the group consisting of alkali metal lactamates, alkaline earth metal lactamates, alkali metals, alkaline earth metals, alkali metal hydrides, alkaline earth metal hydrides, alkali metal hydroxides, alkaline earth metal hydroxides, alkali metal alcoholates, alkaline earth metal alcoholates, alkali metal amides, alkaline earth metal amides, alkali metal oxides, alkaline earth metal oxides and organometallic compounds.

It is particularly preferable that component (B) is selected from alkali metal lactamates and alkaline earth metal lactamates.

Alkali metal lactamates are known per se to the person skilled in the art. Examples of suitable alkali metal lactamates are sodium caprolactamate and potassium caprolactamate.

Examples of suitable alkaline earth metal lactamates are magnesium bromide caprolactamate, magnesium chloride caprolactamate and magnesium biscaprolactamate. Examples of suitable alkali metals are sodium and potassium, and examples of suitable alkaline earth metals are magnesium and calcium. Examples of suitable alkali metal hydrides are sodium hydride and potassium hydride, and examples of suitable alkali metal hydroxides are sodium hydroxide and potassium hydroxide. Examples of suitable alkali metal alcoholates are sodium methanolate, sodium ethanolate, sodium propanolate, sodium butanolate, potassium methanolate, potassium ethanolate, potassium propanolate and potassium butanolate.

In another embodiment to which preference is particularly given, component (B) is selected from the group consisting of sodium hydride, sodium, sodium caprolactamate and a solution of sodium caprolactamate in caprolactam. Particular preference is given to sodium caprolactamate and/or to a solution of sodium caprolactamate in caprolactam (for example Brüggolen C10, from 17 to 19% by weight of sodium caprolactamate and caprolactam). The at least one catalyst can be used in the form of solid or in solution. It is preferable that the at least one catalyst is used in the form of solid. With particular preference, the catalyst is added to a caprolactam melt in which it can be dissolved.

It is clear to the person skilled in the art that when by way of example component (B) is an alkali metal, this reacts on contact with the at least one lactam (component (A)) and thus forms an alkali metal lactamate.

Step b

In step b), the second mixture (M2) is provided. The second mixture (M2) comprises at least one lactam as component (A), at least one activator as component (C) and at least one amine as component (D).

For the purposes of the present invention, the expression “at least one activator” is either precisely one activator or else a mixture of two or more activators. For the purposes of the present invention, the expression “at least one amine” means either precisely one amine or else a mixture of two or more amines.

The second mixture (M2) can be provided in any of the containers known to the person skilled in the art. By way of example, the second mixture (M2) can be provided in a kettle, an extruder or a tank.

It is preferable that the second mixture (M2) comprises from 50 to 99.8% by weight, particularly from 70 to 98% by weight and in particular from 85 to 95% by weight, of component (A), based on the total of the percentages by weight of components (A), (C) and (D), preferably based on the total weight of the second mixture (M2).

It is preferable that the second mixture (M2) moreover comprises from 0.1 to 25% by weight, particularly from 1 to 15% by weight and in particular from 2.5 to 7.5% by weight, of component (C), based on the total of the percentages by weight of components (A), (C) and (D), preferably on the total weight of the second mixture (M2).

It is preferable that the second mixture (M2) moreover comprises from 0.1 to 25% by weight, particularly from 1 to 15% by weight and in particular from 2.5 to 7.5% by weight, of component (D), based in each case on the total of the percentages by weight of components (A), (C) and (D), preferably based on the total weight of the second mixture (M2).

The present invention therefore also provides a process in which the second mixture (M2) provided in step b) comprises from 50 to 99.8% by weight of component (A), from 0.1 to 25% by weight of component (C) and from 0.1 to 25% by weight of component (D), based in each case on the total of the percentages by weight of components (A), (C) and (D), preferably based on the total weight of the second mixture (M2).

The second mixture (M2) can moreover also comprise further components, for example reaction products of the reaction of the at least one activator with the at least one lactam. These reactions and reaction products are known to the person skilled in the art.

It is preferable that the second mixture (M2) comprises no further components.

With particular preference, the second mixture (M2) comprises no component (B), at least one catalyst.

The present invention therefore also provides a process in which the second mixture (M2) provided in step b) comprises no component (B), at least one catalyst.

The percentages by weight of components (A), (C), and (D), and also optionally of the further components, usually give a total of 100%. If there are no further components comprised in the second mixture (M2), the percentages by weight of components (A), (C), and (D) usually give a total of 100%.

The component (A) comprised in the second mixture (M2) can be identical with or different from component (A) comprised in the first mixture (M1). It is preferable that the at least one lactam (component (A)) comprised in the second mixture (M2) is identical with component (A), the at least one lactam, comprised in the first mixture (M1).

The statements and preferences provided above for component (A) comprised in the first mixture (M1) apply correspondingly to component (A) comprised in the second mixture (M2).

Component (C): Activator

In the invention, the second mixture (M2) comprises at least one activator as component (C).

For the purposes of the present invention, the expressions “component (C)” and “at least one activator” are used synonymously and therefore have the same meaning.

An activator suitable as the at least one activator is any of those known to the person skilled in the art that is suitable for activating the anionic polymerization of the at least one lactam (component (A)). It is preferable that the at least one activator is selected from the group consisting of N-substituted lactams, diisocyanates, polyisocyanates, allophanates and diacyl halides; it is particularly preferable that the at least one activator is selected from the group consisting of N-substituted lactams.

The present invention therefore also provides a process in which component (C) is selected from N-substituted lactams, diisocyanates, polyisocyanates, allophanates and diacyl halides.

It is preferable that the N-substituted lactams are electrophilically N-substituted. Examples of suitable electrophilically N-substituted lactams are acyl lactams, for example N-acetylcaprolactam or precursors of these which together with the at least one lactam (component (A)) form an activated lactam in situ. An example of another suitable N-substituted lactam is a capped diisocyanate.

Diisocyanates used can be either aliphatic diisocyanates or aromatic diisocyanates. Among the aliphatic diisocyanates are by way of example butylene diisocyanate, hexamethylene diisocyanate, octamethylene diisocyanate, decamethylene diisocyanate, undodecamethylene diisocyanate, dodecamethylene diisocyanate, 4,4′-methylenebis(cyclohexyl isocyanate) and isophorone diisocyanate. Examples of aromatic diisocyanates are tolylene diisocyanate and 4,4′-methylenebis(phenyl isocyanate). Examples of polyisocyanates are isocyanates of hexamethylene diisocyanate (Basonat HI 100/BASF SE). Examples of suitable allophanates are ethyl allophanates.

Suitable diacyl halides are not only aliphatic diacyl halides but also aromatic diacyl halides. Suitable aliphatic diacyl halides are compounds such as butylenedioyl chloride, butylenedioyl bromide, hexamethylenedioyl chloride, hexamethylenedioyl bromide, octamethylenedioyl chloride, octamethylenedioyl bromide, decamethylenedioyl chloride, decamethylenedioyl bromide, dodecamethylenedioyl chloride, dodecamethylenedioyl bromide, 4,4′-methylenebis(cyclohexyloyl chloride), 4,4′-methylenebis(cyclohexyloyl bromide), isophoronedioyl chloride, and isophoronedioyl bromide; suitable aromatic diacyl halides are compounds such as tolylmethylenedioyl chloride, tolylmethylenedioyl chloride, 4,4′-methylenebis(phenyloyl chloride), 4,4′-methylenebis(phenyloyl bromide).

In a preferred embodiment, component (C) is selected from the group consisting of hexamethylene diisocyanate, isophorone diisocyanate, hexamethylenedioyl bromide, hexamethylenedioyl chloride, and mixtures of these; it is particularly preferable to use hexamethylene diisocyanate.

The at least one activator can be used in solution. In particular, the at least one activator can be dissolved in caprolactam.

An example of another product suitable as at least one activator is Bruggolen® C20, 80% caprolactam-blocked hexamethylene 1,6-diisocyanate in caprolactam from Brüggemann, DE.

Component (D): Amine

In the invention, the second mixture (M2) comprises at least one amine as component (D).

For the purposes of the present invention, the expressions “component (D)” and “at least one amine” are used synonymously and therefore have the same meaning.

The at least one amine preferably comprises at least one NH group and/or at least one NH₂ group.

The at least one NH group and/or the at least one NH₂ group can also be present in the form of protonated NH group and/or as protonated NH₂ group. The protonated NH group takes the form of NH₂⁺ group, and the protonated NH₂ group takes the form of NH₃⁺ group. For the purposes of the present invention, protonated NH groups and protonated NH₂ groups are likewise subsumed under the expressions NH group and NH₂ group. For the determination of the amino functionality, described at a later stage below, of the at least one amine, therefore, the number of protonated NH groups and the number of protonated NH₂ groups is included in the total.

It is clear to the person skilled in the art that protonated NH groups and/or protonated NH₂ groups of the at least one amine can be deprotonated during the polymerization of the polymerizable mixture (pM), and then again take the form of NH group and/or NH₂ group. This is in particular the case when the polymerization of the polymerizable mixture (pM) takes place anionically.

The present invention therefore also provides a process in which component (D) comprises at least one NH group or NH₂ group.

The pKₐ value of the at least one amine is preferably below 26.4.

It is moreover preferable that the amino functionality of the at least one amine is <10, preferably <6 and in particular <3.

The amino functionality of the at least one amine is moreover preferably at least 1.

For the purposes of the present invention, the expression “amino functionality” means the sum of the number of NH groups and the number of NH₂ groups comprised in the at least one amine.

An example of a component (D) preferred for the purposes of the present invention is 1,12-diaminododecane. 1,12-Diaminododecane comprises two NH₂ groups. The amino functionality of 1,12-diaminododecane is therefore 2. Pyrazole is likewise a preferred component (D). Pyrazole comprises one NH group, and its amino functionality is therefore 1.

The present invention therefore also provides a process in which the amino functionality of component (D) is <10.

It is moreover preferable that the molar mass of the at least one amine is <500 g/mol, preferably <200 g/mol and with particular preference <100 g/mol.

The molar mass of the at least one amine is usually at least 20 g/mol, preferably at least 30 g/mol and with particular preference at least 50 g/mol.

The present invention therefore also provides a process in which the molar mass of component (D) is <500 g/mol.

It is preferable that the at least one amine is selected from the group consisting of primary aliphatic amines, primary cycloaliphatic amines, secondary aliphatic amines, secondary cycloaliphatic amines and secondary aromatic amines.

The present invention therefore also provides a process in which component (D) is selected from the group consisting of primary aliphatic amines, primary cycloaliphatic amines, secondary aliphatic amines, secondary cycloaliphatic amines and secondary aromatic amines.

These amines are known per se to the person skilled in the art. With particular preference, the at least one amine is selected from the group consisting of octadecylamine, pentylamine, hexylamine, heptylamine, nonylamine, decylamine, 1,12-diaminododecane, ethylenediamine, propane-1,3-diamine, butane-1,4-diamine, pentane-1,5-diamine, hexane-1,6-diamine, heptane-1,7-diamine, octane-1,8-diamine, nonane-1,9-diamine, decane-1,10-diamine, diethylentriamine, triethylenetetramine, dipropylentriamine, cyclohexylamine, isophorone diamine, 4,4′-diamino-dicyclohexylmethane, dipropylamine, dibutylamine, dipentylamine, dihexylamine, diheptylamine, dioctylamine, dinonylamine, didecylamine, piperidine, piperazine, dicyclohexylamine, pyrazole and imidazole. The at least one amine is most preferably pyrazole.

The present invention therefore also provides a process in which component (D) is selected from the group consisting of octadecylamine, pentylamine, hexylamine, heptylamine, nonylamine, decylamine, 1,12-diaminododecane, ethylenediamine, propane-1,3-diamine, butane-1,4-diamine, pentane-1,5-diamine, hexane-1,6-diamine, heptane-1,7-diamine, octane-1,8-diamine, nonane-1,9-diamine, decane-1,10-diamine, diethylentriamine, triethylenetetramine, dipropylentriamine, cyclohexylamine, isophorone diamine, 4,4′-diaminodicyclohexylmethane, dipropylamine, dibutylamine, dipentylamine, dihexylamine, diheptylamine, dioctylamine, dinonylamine, didecylamine, piperidine, piperazine, dicyclohexylamine, pyrazole and imidazole.

With particular preference, component (D) is selected from imidazole, octadecylamine, 1,12-diaminododecane, piperidine, dibutylamine and pyrazole.

Step c)

In step c), the first mixture (M1) is mixed with the second mixture (M2) to give a polymerizable mixture (pM).

Any of the methods known to the person skilled in the art is suitable for the mixing of the first mixture (M1) with the second mixture (M2). By way of example, the first mixture (M1) and the second mixture (M2) are mixed while they are injected into a mold.

The first mixture (M1) and the second mixture (M2) can be mixed directly in the mold to give the polymerizable mixture (pM). Equally, it is possible, and preferred in the invention, that the first mixture (M1) and the second mixture (M2) are mixed in a suitable mixing device to give the polymerizable mixture (pM) which then is subsequently introduced into a mold. It is preferable that the polymerizable mixture (pM) is produced and subsequently introduced into a mold. These mixing devices are known per se to the person skilled in the art and by way of example are static and/or dynamic mixers.

The temperature during the mixing of the first mixture (M1) with the second mixture (M2) can be in any desired range. It is preferable that this temperature is in the range from 80 to 140° C., particularly in the range from 100 to 130° C. and most preferably in the range from 110 to 125° C.

The present invention therefore also provides a process in which, in step c), the first mixture (M1) is mixed with the second mixture (M2) at a temperature in the range from 80 to 140° C.

Step c) can be carried out at any desired pressure.

It is preferable that the polymerizable mixture (pM) obtained in step c) is in liquid form.

The polymerizable mixture (pM) is preferably obtained by mixing of from 1 to 99% by weight, preferably from 4 to 98% by weight and most preferably from 45 to 55% by weight, of the first mixture (M1) with from 1 to 99% by weight, preferably from 2 to 96% by weight, and with particular preference from 45 to 55% by weight, of the second mixture (M2), based on the sum of the percentages by weight of the first mixture (M1) and of the second mixture (M2), particularly preferably based on the total weight of the polymerizable mixture (pM).

The polymerizable mixture (pM) obtained in step c) therefore comprises by way of example from 1 to 99% by weight of the first mixture (M1) and from 1 to 99% by weight of the second mixture (M2), preferably from 4 to 98% by weight of the first mixture (M1) and from 2 to 96% by weight of the second mixture (M2), and most preferably from 45 to 55% by weight of the first mixture (M1) and from 45 to 55% by weight of the second mixture (M2), based in each case on the sum of the percentage by weight of the first mixture (M1) and of the second mixture (M2), preferably based on the total weight of the polymerizable mixture (pM).

It is clear to the person skilled in the art that the components (A), (B), (C) and (D), and also optionally the further components, comprised in the polymerizable mixture (pM) obtained in step c) are those that were comprised in the first mixture (M1) provided in step a) and in the second mixture (M2) provided in step b).

It is moreover clear to the person skilled in the art that the components which were comprised in the first mixture (M1) and in the second mixture (M2) can also already have reacted with one another to some extent in the polymerizable mixture (pM). However, it is preferable that no polyamide (P) is yet formed here. These reactions are known to the person skilled in the art, an example being the reaction of the at least one catalyst (component B)) with the at least one lactam (component (A)), where these can form a lactamate.

The polymerizable mixture (pM) usually comprises from 55 to 99.7% by weight of component (A), preferably from 76 to 99% by weight, and with particular preference from 85 to 98% by weight of component (A), based on the sum of the percentages by weight of components (A), (B), (C) and (D), preferably based on the total weight of the polymerizable mixture (pM).

The polymerizable mixture (pM) obtained in step c) moreover usually comprises from 0.1 to 10% by weight of component (B), preferably from 0.1 to 7% by weight, and with particular preference from 0.1 to 5% by weight, based in each case on the sum of the percentages by weight of components (A), (B), (C) and (D), preferably based on the total weight of the polymerizable mixture (pM).

The polymerizable mixture (pM) moreover usually comprises from 0.1 to 10% by weight of component (C), preferably from 0.1 to 7% by weight, and with particular preference from 0.1 to 5% by weight, based in each case on the sum of the percentages by weight of components (A), (B), (C) and (D), preferably based on the total weight of the polymerizable mixture (pM).

The polymerizable mixture (pM) moreover usually comprises from 0.1 to 25% by weight of component (D), preferably from 0.1 to 10% by weight, and with particular preference from 0.1 to 5% by weight, based in each case on the sum of the percentages by weight of components (A), (B), (C) and (D), preferably based on the total weight of the polymerizable mixture (pM).

The present invention therefore also provides a process in which the polymerizable mixture (pM) obtained in step c) comprises, based in each case on the total weight of the polymerizable mixture (pM), from 55 to 99.7% by weight of component (A), from 0.1 to 10% by weight of component (B), from 0.1 to 10% by weight of component (C) and from 0.1 to 25% by weight of component (D).

The percentages by weight of components (A), (B), (C) and (D) comprised in the polymerizable mixture (pM) usually give a total of 100%.

Unless otherwise stated, all percentages by weight of components (A), (B), (C) and (D) are based on components (A), (B), (C) and (D) before the components have reacted with one another.

Step d)

In step d), the polymerizable mixture (pM) obtained in step c) is polymerized to give the polyamide (P).

The container in which the polymerizable mixture (pM) is polymerized can by way of example be that in which it was obtained by mixing of the first mixture (M1) with the second mixture (M2). Equally, it is possible to transfer the polymerizable mixture (pM), after step c) and before step d), into a container in which the polymerizable mixture (pM) is then polymerized.

If the polymerizable mixture (pM) is by way of example obtained in a mold in step c), it can be polymerized therein in step d). If, in contrast, the polymerizable mixture (pM) is obtained in a mixing device in step c), it can then be transferred into a mold and then polymerized therein in step d).

Step d) is usually carried out at a temperature in the range from 130 to 160° C., preferably in the range from 135 to 155° C. and with particular preference in the range from 140 to 150° C.

Step d) can be carried out at any desired pressure.

The polymerization of the polymerizable mixture (pM) obtained in step c) usually begins after an induction period in the range from 0.1 to 20 minutes, preferably in the range from 1 to 15 minutes and in particular in the range from 2 to 12 minutes.

The induction period is determined as described hereinafter in the invention.

The first mixture (M1) (0.4 g) is charged under an inert atmosphere (nitrogen) in a 100 ml glass calorimeter reactor sealed by a grease-free Teflon stopper and equipped with a temperature sensor, and is heated to the temperature at which the polymerization of the polymerizable mixture (pM) takes place according to step d), for example 140° C. Once the temperature has been reached, the second mixture (M2) (9.6 g) is added to the first mixture (M1) with stirring, and the polymerizable mixture (pM) is thus obtained. During the addition of the second mixture (M2) to the first mixture (M1), the first mixture cools. The juncture at which addition of the second mixture (M2) to the first mixture (M1) has been completed is termed start point tₛₜₐᵣₜ. The start point tₛₜₐᵣₜ is the juncture from which the induction period is measured.

It is also possible to use the second mixture (M2) as initial charge and to add the first mixture (M1) once the temperature has been reached at which the polymerization of the polymerizable mixture (pM) takes place according to step d). The start point tₛₜₐᵣₜ is then the juncture at which addition of the first mixture (M1) to the second mixture (M2) has been completed. This embodiment is preferred.

The 100 ml glass calorimeter reactor is fitted into a Julabo thermostatic heater using oil bath. The measurement equipment used to record the temperature is an Ahlborn Almemo 2590, and the thermocouple used is a type K (NiCr—Ni) sleeved thermocouple with sleeve diameter 1.0 mm and sleeve length 250 mm. These thermocouples are obtainable by way of example from “Fühlersysteme eNET international”.

As soon as the start point tₛₜₐᵣₜ has been reached, the polymerizable mixture (pM) is again heated to the temperature at which the polymerization of the polymerizable mixture (pM) takes place according to step d), for example 140° C. The thermocouple is used to measure the temperature of the polymerizable mixture (pM) as a function of time, starting from the start point tₛₜₐᵣₜ.

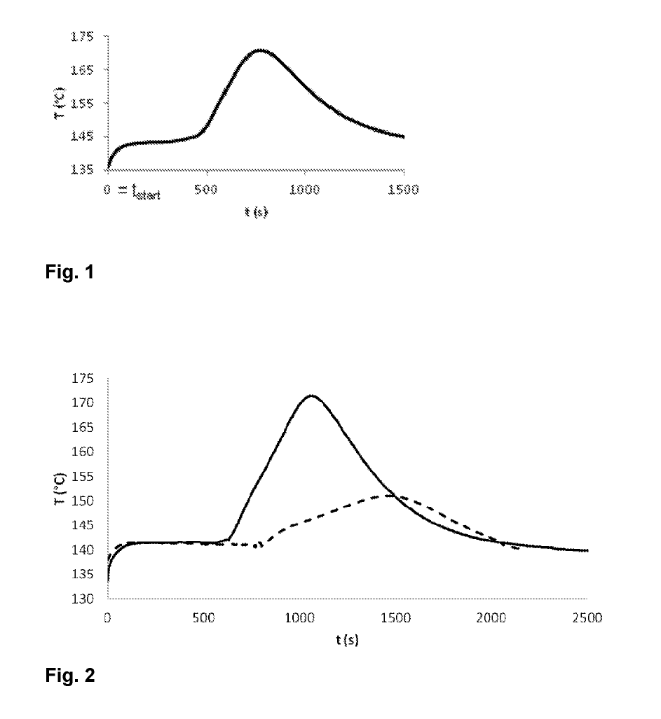

This gives the curve that can be seen in FIG. 1. The time tin seconds (s) is plotted on the x-axis, and the temperature T of the polymerizable mixture in ° C. is plotted on the y-axis. 0 indicates the start point tₛₜₐᵣₜ. Beginning at the start point tₛₜₐᵣₜ, the temperature of the polymerizable mixture (pM) initially increases, because the polymerizable mixture (pM) is heated to the temperature at which the polymerization of the polymerizable mixture (pM) takes place in step d). As soon as this temperature has been reached, the temperature remains almost unchanged for a period t_{const}. The expression “almost unchanged” means a temperature change of at most +/−10° C., preferably of at most +/−7° C. and with particular preference at most +/−5° C.

After the period t_{const} in which the temperature remains almost unchanged, the temperature generally increases as the polymerization of the polymerizable mixture (pM) begins, at the juncture t_{poly}, for example by from 10 to 70° C., preferably by 15 to 50° C. and with particular preference by from 20 to 40° C. Without any intention of restricting the invention to this interpretation, it appears rightly that the reason for the temperature increase is that the polymerization of the polymerizable mixture (pM) proceeds exothermically. The crystallization of the polyamide (P) that forms during the polymerization of the polymerizable mixture (pM) also proceeds exothermically. The reason for the temperature increase is therefore not only the exothermic polymerization of the polymerizable mixture (pM) but also the exothermic crystallization of the resultant polyamide (P). A maximal temperature Tₘₐₓ is reached here after a period tₘₐₓ. The polymerizable mixture (pM) then cools, whereupon the polyamide (P) is obtained.

The juncture t_{poly} at which the polymerization of the polymerizable mixture (pM) begins is determined in the invention by drawing a tangent at the inflection point at the region of the almost unchanged temperature and another tangent at the inflection point at the region of the temperature increase by, for example, from 10 to 70° C., preferably from 15 to 50° C. and with particular preference from 20 to 40° C. Vertical extrapolation of the intersection of the two tangents to the time axis then gives the juncture t_{poly} at which the polymerization of the polymerizable mixture (pM) begins.

In another embodiment of the present invention, the juncture t_{poly} at which the polymerization of the polymerizable mixture (pM) begins is determined by measuring the heating rate β in the polymerizable mixture (pM). The heating rate β can be determined from the curve, determined as described above, that shows the temperature of the polymerizable mixture (pM) as a function of time. The heating rate β is defined as the change in the temperature of the polymerizable mixture (pM) as a function of time. From the start point tₛₜₐᵣₜ until the temperature is reached at which the polymerization of the polymerizable mixture (pM) is carried out in step d), the heating rate β is generally in the range from 1 to 6 K/min. Therefore 1<β<6 K/min. During the period t_{const} during which the temperature is almost unchanged, the heating rate β is less than 1 K/min, and therefore β<1 K/min. From the beginning of the polymerization of the polymerizable mixture (pM) and therefore from the juncture t_{poly}, the heating rate β is above 2 K/min, and therefore β>2 K/min. The juncture t_{poly} at which the polymerization of the polymerizable mixture (pM) begins is then therefore defined as the first juncture at which, after expiry of the period t_{const}, β>2 K/min.

The period starting at the start point tₛₜₐᵣₜ at which addition of the second mixture (M2) to the first mixture (M1) has been completed, or addition of the first mixture (M1) to the second mixture (M2) has been completed, and finishing at the juncture t_{poly} at which the polymerization of the polymerizable mixture (pM) beings is defined in the invention as the induction period.

The polymerization of the polymerizable mixture (pM) is therefore retarded by virtue of the process of the invention for a period in the range from 0.1 to 20 min, preferably in the range from 1 to 15 min and with particular preference in the range from 2 to 12 min. This period is also termed induction period, and is determined as described above.

The present invention therefore also provides a process in which the polymerization of the polymerizable mixture (pM) in step d) is retarded for a period in the range from 0.1 to 20 min.

Step c) and step d) can also be carried out simultaneously. It is preferable that step c) and step d) are carried out in succession.

The polyamide (P) obtained in step d) can comprise from 1 to 50% by weight, preferably from 1.5 to 40% by weight and with particular preference from 2 to 30% by weight, of at least one filler, based on the total weight of the polyamide (P).

The at least one filler can by way of example be already comprised in the first mixture (M1) provided in step a), but it is equally possible that the at least one filler is comprised in the second mixture (M2) provided in step b). It is preferable that the filler is comprised in the mold in which the polymerizable mixture (pM) is polymerized in step d).

The present invention therefore also provides a process in which the polyamide (P) obtained in step d) additionally comprises from 1 to 50% by weight of at least one filler, based on the total weight of the polyamide (P).

Polyamide (P)

In step d), the polyamide (P) is obtained.

The crystallinity of the polyamide (P) is usually in the range from 10% to 70%, preferably in the range from 20% to 60% and with particular preference in the range from 25% to 40%, determined by differential scanning calorimetry (DSC). Methods for determining the crystallinity of the polyamide (P) by DSC are known to the person skilled in the art.

The melting point of the resultant polyamide (P) is by way of example in the range from >160 to 280° C., preferably in the range from 180 to 250° C. and with particular preference in the range from 200 to 230° C.

The glass transition temperature of the resultant polyamide (P) is by way of example in the range from 20 to 150° C., preferably in the range from 30 to 110° C. and with particular preference in the range from 40 to 80° C.

The melting point and the glass transition temperature of the resultant polyamide (P) are determined by differential scanning calorimetry (DSC). Methods of this are known to the person skilled in the art.

The proportion of unreacted component (A) in the resultant polyamide (P) is usually in the range from 0.01 to 6% by weight, preferably in the range from 0.1 to 3% by weight and with particular preference in the range from 1 to 2% by weight, based in each case on the total weight of the resultant polyamide (P).

The intrinsic viscosity of the resultant polyamide (P) is usually in the range from 50 to 1000, preferably in the range from 200 to 800 and with particular preference in the range from 400 to 750, determined using 96% sulfuric acid as solvent at a temperature of 25° C. with a DIN Ubbelohde II capillary.

The present invention therefore moreover provides a polyamide (P) obtainable by the process of the invention.

The present invention moreover provides a molding made of the polyamide (P) of the invention.

Examples are used below to provide further explanation of the present invention, but the invention is not restricted thereto.

### EXAMPLES

The following components were used:

(A) Lactam
Caprolactam (BASF SE, Ludwigshafen)

(B) Catalyst
Brüggolen C10 (17-19% by weight of sodium caprolactamate in caprolactam) (Brüggemann KG, Heilbronn)

(C) Activator
Brüggolen C20 (80% by weight of hexamethylene-1,6-dicarbamoylcaprolactam in caprolactam) (Brüggemann KG, Heilbronn)

(D) Additives
Pyrazole 98% (abcr GmbH & Co. KG, Karlsruhe)
Imidazole 99% (Merck KGaA, Darmstadt)
1-Octadecylamine 98% (abcr GmbH & Co. KG, Karlsruhe)
1,12-Diaminododecane 98% (Sigma-Aldrich, Taufkirchen)
Piperidine 99% (Sigma-Aldrich, Taufkirchen)
Dibutylamine 99.5% (Sigma-Aldrich, Taufkirchen)
1-Methylpyrazole 97% (abcr GmbH & Co. KG, Karlsruhe)
1-Methylimidazole 99% (Merck KGaA, Darmstadt)
1,2-Dimethylimidazole 98% (abcr GmbH & Co. KG, Karlsruhe)
Pyridine 99.5% (Carl Roth GmbH+Co. KG, Karlsruhe)
N,N-Dimethylaminopyridine (DMAP) (Sigma-Aldrich, Taufkirchen)
N,N-Dimethylaniline 99% (Acros, Nidderau)

All components were weighed into the system under nitrogen and prepared for the polymerization. The reaction vessel, a 100 mL glass calorimeter reactor, was sealed with a grease-free Teflon stopper and equipped with a thermocouple. The polymerization reactions took place with stirring under dry nitrogen at 140° C. One temperature measurement per second was recorded here, and these measurements were used to generate the respective temperature-time graph of the reaction.

### Comparative Example 1

9.4 g of caprolactam were heated to 140° C. 0.4 g (4% by weight, 0.6 mol %) of catalyst (Brüggolen C10) was added and the mixture was again heated to reach the reaction temperature, and then the polymerization was started by adding 0.2 g (2% by weight, 0.5 mol %) of activator (Brüggolen C20). After 15 min, the anionic polymerization was quenched by cooling of the reaction vessel in ice/water (0° C.).

### Comparative Example 2

Comparative example 1 was repeated, except that 9.325 g of caprolactam and 0.075 g (0.75% by weight, 1.0 mol %) of 1-methylimidazole were used.

### Comparative Example 3

Comparative example 1 was repeated, except that 9.315 g of caprolactam and 0.085 g (0.85% by weight, 1.0 mol %) of 1,2-dimethylimidazole were used.

### Comparative Example 4

Comparative example 1 was repeated, except that 9.325 g of caprolactam and 0.075 g (0.75% by weight, 1.0 mol %) of 1-methylpyrazole were used.

### Comparative Example 5

Comparative example 1 was repeated, except that 9.33 g of caprolactam and 0.07 g (0.7% by weight, 1.0 mol %) of pyridine were used.

### Comparative Example 6

Comparative example 1 was repeated, except that 9.29 g of caprolactam and 0.11 g (1.1% by weight, 1.0 mol %) of DMAP were used.

### Comparative Example 7

Comparative example 1 was repeated, except that 9.29 g of caprolactam and 0.11 g (1.1% by weight, 1.0 mol %) of N,N-dimethylaniline were used.

For comparative examples 1 to 7, table 1 shows the induction period (t_{induction}) and the maximal temperature Tₘₐₓ reached after the period tₘₐₓ.

TABLE 1

| Comparative | | t_{Induction} | tₘₐₓ | Tₘₐₓ |
|---|---|---|---|---|
| example | Amine | [min] | [min] | [° C.] |
| 1 | — | 0 | 1.0 | 186.6 |
| 2 | 1-Methylimidazole | 0 | 1.0 | 179.2 |
| 3 | 1,2-Dimethylimidazole | 0 | 1.2 | 175.5 |
| 4 | 1-Methylpyrazole | 0 | 1.1 | 175.6 |
| 5 | Pyridine | 0 | 1.0 | 182.7 |
| 6 | DMAP | 0 | 1.2 | 183.4 |
| 7 | N,N-Dimethylaniline | 0 | 1.1 | 183.6 |

### Inventive Example 8

9.39 g of caprolactam and 0.01 g (0.1% by weight, 0.2 mol %) of imidazole were heated to 140° C. 0.2 g (2% by weight, 0.5 mol %) of activator (Brüggolen C20) was added and the mixture was again heated to reach the reaction temperature, and then the polymerization was started by adding 0.4 g (4% by weight, 0.6 mol %) of catalyst (Brüggolen C10). After cooling to final temperature (45 min), the anionic polymerization was quenched by cooling of the reaction vessel in ice/water (0° C.).

### Inventive Example 9

Inventive example 8 was repeated, except that 9.225 g of caprolactam and 0.175 g (1.75% by weight, 0.75 mol %) of 4-octadecylamine were used.

### Inventive Example 10

Inventive example 8 was repeated, except that 9.313 g of caprolactam and 0.087 g (0.87% by weight, 0.5 mol %) of 1,12-diaminododecane were used.

### Inventive Example 11

Inventive example 8 was repeated, except that 9.344 g of caprolactam and 0.056 g (0.56% by weight, 0.75 mol %) of piperdine were used.

### Inventive Example 12

Inventive example 8 was repeated, except that 9.315 g of caprolactam and 0.085 g (0.85% by weight, 0.75 mol %) of dibutylamine were used.

### Inventive Example 13

Caprolactam and pyrazole were heated to 140° C. 0.2 g (2% by weight, 0.5 mol %) of activator (Brüggolen C20) was added and the mixture was again heated to reach the reaction temperature, and then the polymerization was started by adding 0.4 g (4% by weight, 0.6 mol %) of catalyst (Brüggolen C10). After cooling to final temperature (45 min), the anionic polymerization was quenched by cooling of the reaction vessel in ice/water (0° C.).

Table 2 shows the quantities used of caprolactam and pyrazole.

TABLE 2

| Inv. | Caprolactam | Pyrazole | Pyrazole | Pyrazole |
|---|---|---|---|---|
| ex. | [g] | [g] | [% by wt.] | [mol %] |
| 13a | 9.37 | 0.03 | 0.3 | 0.5 |
| 13b | 9.365 | 0.036 | 0.36 | 0.6 |
| 13c | 9.358 | 0.042 | 0.42 | 0.7 |
| 13d | 9.35 | 0.05 | 0.48 | 0.8 |
| 13e | 9.345 | 0.055 | 0.55 | 0.9 |
| 13f | 9.34 | 0.06 | 0.6 | 1.0 |
| 13g | 9.33 | 0.07 | 0.7 | 1.2 |
| 13h | 9.325 | 0.075 | 0.75 | 1.3 |

### Inventive Example 14

9.34 g of caprolactam, 0.06 g (0.6% by weight, 1.0 mol %) of pyrazole and 0.2 g (2% by weight, 0.5 mol %) of activator (Brüggolen C20) were weighed into the reaction vessel and securely sealed by means of a silicone septum. The mixture was heated to 140° C. for x min (x=0, 5, 15, 22.5, 30, 60) and the septum was then quickly replaced by the Teflon stopper with thermocouple. The polymerization was started by adding 0.4 g (4% by weight, 0.6 mol %) of catalyst (Brüggolen C10), and after cooling to final temperature (45 min) was quenched by cooling of the reaction vessel in ice/water (0° C.).

For inventive examples 8 to 14, table 3 shows the induction period (t_{induction}) and the maximal temperature Tₘₐₓ reached after the period tₘₐₓ.

TABLE 3

| Inv. | | t_{Induction} | tₘₐₓ | Tₘₐₓ |
|---|---|---|---|---|
| ex. | Amine | [min] | [min] | [° C.] |
| 8 | Imidazole, 0.2 mol % | 2.4 | 6.7 | 170.5 |
| 9 | 1-Octadecylamine, 0.75 mol % | 5.5 | 16.2 | 150.7 |
| 10 | 1,12-Diaminododecane, 0.5 mol % | 12 | 19.8 | 146.6 |
| 11 | Piperidine, 0.75 mol % | 3.8 | 7.6 | 180.7 |
| 12 | 0.75 mol % of dibutylamine | 2.6 | 6.7 | 185.1 |
| 13a | 0.5 mol % of pyrazole | 3.4 | 6.6 | 177.3 |
| 13b | 0.6 mol % of pyrazole | 3.7 | 7.4 | 172.9 |
| 13c | 0.7 mol % of pyrazole | 7.0 | 14.0 | 163.0 |
| 13d | 0.8 mol % of pyrazole | 7.3 | 12.8 | 172.1 |
| 13e | 0.9 mol % of pyrazole | 7.3 | 14.8 | 164.3 |
| 13f | 1.0 mol % of pyrazole | 7.1 | 12.6 | 171.3 |
| 13g | 1.2 mol % of pyrazole | 9.7 | 18.8 | 165.5 |
| 13h | 1.3 mol % of pyrazole | 10.7 | 17.8 | 161.2 |
| 14a | 1.0 mol % of pyrazole, x = 0 | 7.1 | 12.6 | 171.3 |
| 14b | 1.0 mol % of pyrazole, x = 5 | 7.5 | 12.5 | 170.7 |
| 14c | 1.0 mol % of pyrazole, x = 15 | 7.8 | 13.7 | 168.4 |
| 14d | 1.0 mol % of pyrazole, x = 22.5 | 7.8 | 13.1 | 172.5 |
| 14e | 1.0 mol % of pyrazole, x = 30 | 6.0 | 9.7 | 167.0 |
| 14f | 1.0 mol % of pyrazole, x = 60 | 7.8 | 13.0 | 172.0 |

### Inventive Example 15

9.325 g of caprolactam and 0.075 g (0.75% by weight, 1.3 mol %) of pyrazole were heated to 140° C. 0.2 g (2% by weight, 0.5 mol %) of activator (Brüggolen C20) was added and the mixture was again heated to reach the reaction temperature, and then the polymerization was started by adding 0.4 g (4% by weight, 0.6 mol %) of catalyst (Brüggolen C10). After 45 min, the anionic polymerization was quenched by cooling of the reaction vessel in ice/water (0° C.). The maximal temperature Tₘₐₓ is 171.5° C., and the proportion of unreacted component (A) (caprolactam) is 5.74% by weight.

### Comparative Example 16

9.325 g of caprolactam and 0.075 g (0.75% by weight, 1.3 mol %) of pyrazole were heated to 140° C. 0.4 g (4% by weight, 0.6 mol %) of catalyst (Brüggolen C10) was added and the mixture was again heated to reach the reaction temperature, and then the polymerization was started by adding 0.2 g (2% by weight, 0.5 mol %) of activator (Brüggolen C20). After 45 min, the anionic polymerization was quenched by cooling of the reaction vessel in ice/water (0° C.). The maximal temperature Tₘₐₓ is 151.0° C., and the proportion of unreacted component (A) (caprolactam) is 14.98% by weight.

The temperature-time graph for inventive example 15 (continuous line) and comparative example 16 (broken line) can be seen in FIG. 2. The time tin seconds (s) is plotted on the x-axis, and the temperature T in ° C. is plotted on the y-axis. It can be seen that the period for which the polymerization is retarded in inventive example 15 is similar to that in comparative example 16. However, progress of the reaction after the induction period is significantly faster and more complete in inventive example 15 than in comparative example 16. The faster reaction can be seen from the steeper rise of the curve to the maximal temperature Tₘₐₓ.

From comparison of inventive example 15 with comparative example 16 it can moreover be seen that a significantly smaller proportion of unreacted component (A) in the resultant polyamide (P) is achieved with the process of the invention.

1. A process for the production of a polyamide (P), comprising the following steps:
a) of providing a first mixture (M1) which comprises the following components:
(A) at least one lactam, and
(B) at least one catalyst,
b) providing a second mixture (M2) which comprises the following components:
(A) at least one lactam,
(C) at least one activator, and
(D) at least one amine,
c) mixing of the first mixture (M1) with the second mixture (M2) to give a polymerizable mixture (pM), and
d) polymerization of the polymerizable mixture (pM) obtained in step c) to give the polyamide (P).

2. The process according to claim 1, wherein component (D) comprises at least one NH group or NH₂ group.

3. The process according to claim 1 or 2, wherein component (D) is selected from the group consisting of primary aliphatic amines, primary cycloaliphatic amines, secondary aliphatic amines, secondary cycloaliphatic amines and secondary aromatic amines.

4. The process according to claim 1, wherein component (A) comprises at least one lactam having from 4 to 12 carbon atoms.

5. The process according to claim 1, wherein component (A) is selected from the group consisting of pyrrolidone, piperidone, ε-caprolactam, enantholactam, caprylolactam, capric lactam and laurolactam.

6. The process according to claim 1, wherein component (B) is selected from the group consisting of alkali metal lactamates, alkaline earth metal lactamates, alkali metals, alkaline earth metals, alkali metal hydrides, alkaline earth metal hydrides, alkali metal hydroxides, alkaline earth metal hydroxides, alkali metal alcoholates, alkaline earth metal alcoholates, alkali metal amides, alkaline earth metal amides, alkali metal oxides, alkaline earth metal oxides and organometallic compounds.

7. The process according to claim 1, wherein, in step c), the first mixture (M1) is mixed with the second mixture (M2) at a temperature in the range from 80 to 140° C.

8. The process according to claim 1, wherein component (C) is selected from N-substituted lactams, diisocyanates, polyisocyanates, allophanates and diacyl halides.

9. The process according to claim 1, wherein the polyamide (P) obtained in step d) additionally comprises from 1 to 50% by weight of at least one filler, based on a total weight of the polyamide (P).

10. The process according to claim 1, wherein the polymerizable mixture (pM) obtained in step c) comprises, based in each case on a total weight of the polymerizable mixture (pM), from 55 to 99.7% by weight of component (A), from 0.1 to 10% by weight of component (B), from 0.1 to 10% by weight of component (C) and from 0.1 to 25% by weight of component (D).

11. The process according to claim 2, wherein an amino functionality of component (D) is <10.

12. The process according to claim 1, wherein a molar mass of component (D) is <500 g/mol.

13. A polyamide (P) obtainable by a process according to claim 1.

14. A molding made of the polyamide (P) according to claim 13.
